(19) United States
(12) Patent Application Publication
(10) Pub. No.: US 2009/0036623 A1
(43) Pub. Date: Feb. 5, 2009

(54) PROCESS FOR PRODUCING CONJUGATED POLYMER

(75) Inventors: Yoshihiro Tsuda, Ibaraki (JP); Yoshii Morishita, Ibaraki (JP); Satoyuki Nomura, Ibaraki (JP); Yousuke Hoshi, Ibaraki (JP); Shigeaki Funyuu, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: HITACHI CHEMICAL CO., LTD., Tokyo (JP)

(21) Appl. No.: 11/915,176

(22) PCT Filed: May 18, 2006
(86) PCT No.: PCT/JP2006/309896

§ 371 Date: Nov. 21, 2007

(30) Foreign Application Priority Data
May 24, 2005 (JP) 2005-151256

(51) Int. Cl. C08F 214/18

(52) U.S. Cl. 526/242

(57) ABSTRACT

An object of the present invention is to provide a process for producing a conjugated polymer that enables a significant shortening of the reaction time. A process for producing a conjugated polymer according to the present invention is a process for producing a conjugated polymer by Suzuki coupling, wherein the process uses microwave irradiation. The conjugated polymer is preferably a polymer used as an organic electronics material, and is even more preferably a polymer used as an electroluminescent material.

### TECHNICAL FIELD

The present invention relates to a process for producing a conjugated polymer. The present invention preferably relates to a process for producing a conjugated polymer used in an organic electronics material such as an electroluminescent device. Furthermore, the present invention also relates to an organic electronics material and an electroluminescent material produced using the above process for producing a conjugated polymer, and an electroluminescent device that uses the above electroluminescent material.

### BACKGROUND ART

Electroluminescent devices are attracting considerable attention, for example as large-area solid state light sources capable of replacing incandescent lamps and gas-filled lamps. On the other hand, these materials are also attracting attention as the most promising self-luminous display capable of replacing liquid crystal displays within the field of flat panel displays (FPD). In particular, organic electroluminescent (EL) devices in which the device material comprises an organic material are now being commercialized as low power consumption full-color FPD products. Of the various devices, polymer-based organic EL devices in which the organic material comprises a polymer material enable far easier film formation, using printing or inkjet application or the like, than low molecular weight organic EL devices that require film formation within a vacuum system, and will consequently be indispensable devices in future large-screen organic EL displays.

Conventionally, polymer-based organic EL devices have employed either a conjugated polymer such as poly(p-phenylene-vinylene) (for example, see International Patent Publication No. 90/13148, pamphlet) or a non-conjugated polymer (for example, see I. Sokolik, et al., J. Appl. Phys. 1993. 74, 3584) as the polymer material. However, their luminescent lifetime as a device is short, which gives rise to problems when constructing a full-color display.

With the object of solving these problems, polymer-based organic EL devices employing various types of polyfluorene-based and poly(p-phenylene)-based conjugated polymers have been proposed in recent years. However, these devices are not satisfactory in terms of stability.

One effective process for synthesizing polyfluorene-based and poly(p-phenylene)-based conjugated polymers is the Suzuki coupling reaction (for example, see Synthetic Communications 11(7), 513, 1981). This reaction typically employs the reaction raw material monomers, together with a palladium catalyst, an inorganic base comprising a water-soluble alkali carbonate or bicarbonate salt, a solvent, and if required a polymer product. The reaction raw material monomers typically include a diboronic acid monomer or diboronate monomer, and a dibromo monomer.

This type of Suzuki coupling reaction usually requires the use of an non-polar solvent such as toluene as the solvent. However, this type of non-polar solvent has been shown to reduce the reaction rate. In order to address this type of disadvantage, a process has been proposed that uses a phase transfer catalyst such as tricaprylmethylammonium chloride, which is known as Aliquat (a registered trademark), to increase the reaction rate (for example, see U.S. Pat. No. 5,777,070). In this process, the reaction mixture comprises an organic solvent such as toluene, an inorganic base such as sodium bicarbonate, a catalytic quantity of a palladium complex, and a catalytic quantity of the phase transfer catalyst.

### DISCLOSURE OF INVENTION

Synthesis of a conjugated polymer by Suzuki coupling usually requires an extended reaction time (of 10 hours or longer), even when an aforementioned phase transfer catalyst is used. When the reaction time is this long, concerns arise over discoloration of the polymer product and decomposition of the catalysts.

The present invention aims to resolve these concerns. In other words, an object of the present invention is to provide a process for producing a polymer that enables a significant shortening of the reaction time. Furthermore, another object of the present invention is to provide an organic electronics material, an electroluminescent material and an electroluminescent device that uses such an electroluminescent material which, when compared with the case using a conventional Suzuki coupling, exhibit superior properties and productivity.

In other words, the present invention relates to a process for producing a conjugated polymer by Suzuki coupling, wherein the process uses microwave irradiation. In the production process of the present invention, the conjugated polymer is preferably a material used in an organic electronics device, and the conjugated polymer is even more preferably a material used in an electroluminescent device.

The conjugated polymer can be used as a material for a light-emitting layer, as a material for an electron or positive hole transport layer, and as a material for an electron or positive hole blocking layer.

Furthermore, the present invention also relates to an organic electronics material produced using the above process for producing a conjugated polymer.

Furthermore, the present invention also relates to an electroluminescent material produced using the above process for producing a conjugated polymer.

Moreover, the present invention also relates to an electroluminescent device that uses the above electroluminescent material.

The present disclosure relates to subject matter contained in Japanese Application 2005-151256, filed on May 24, 2005, the disclosure of which is incorporated by reference herein.

### BEST MODE FOR CARRYING OUT THE INVENTION

As follows is a detailed description of embodiments of the present invention.

A production process of the present invention is a process for producing a conjugated polymer by Suzuki coupling, wherein the conjugated polymer is produced by microwave irradiation.

In the present invention, the term “conjugated polymer” refers to either a completely conjugated polymer, that is, a polymer that is conjugated throughout the entire length of the polymer chain, or a partially conjugated polymer, that is, a polymer that includes both a conjugated portion and a non-conjugated portion.

There are no particular restrictions on the monomers used in the process for producing a conjugated polymer according to the present invention, and any of the monomers that can be used to form a conjugated polymer by a Suzuki coupling reaction may be used.

Examples of monomers that can be used in a process for producing a conjugated polymer according to the present invention include monomers that contain a structure such as a substituted or unsubstituted arylene, substituted or unsubstituted heteroarylene, or metal coordination compound. Specific examples include monomers that contain either one, or two or more structures selected from amongst benzene, naphthalene, anthracene, phenanthrene, chrysene, rubrene, pyrene, perylene, indene, azulene, adamantane, fluorene, fluorenone, dibenzofuran, carbazole, dibenzothiophene, furan, pyrrole, pyrroline, pyrrolidine, thiophene, dioxolane, pyrazole, pyrazoline, pyrazolidine, imidazole, oxazole, thiazole, oxadiazole, triazole, thiadiazole, pyran, pyridine, piperidine, dioxane, morpholine, pyridazine, pyrimidine, pyrazine, piperazine, triazine, trithiane, norbomene, benzofuran, indole, benzothiophene, benzimidazole, benzoxazole, benzothiazole, benzothiadiazole, benzoxadiazole, purine, quinoline, isoquinoline, coumarin, cinnoline, quinoxaline, acridine, phenanthroline, phenothiazine, flavone, triphenylamine, acetylacetone, dibenzoylmethane, picolinic acid, silole, porphyrin, and coordination compounds of a metal such as iridium. In the process for producing a conjugated polymer according to the present invention, either a single monomer may be used alone, or two or more different monomers may be used.

The monomers used in the process for producing a conjugated polymer according to the present invention usually contain functional groups suitable for a Suzuki coupling reaction. Examples of preferred combinations of functional groups that are suitable for a Suzuki coupling reaction include combinations of a boron derivative functional group and a functional group capable of a coupling reaction with this boron derivative functional group.

Examples of boron derivative functional groups include a boronic acid group that is ideally represented by —B(OH)₂, a boronate ester group that is ideally represented by —B(OR¹)(OR²) or —B(OR⁵O), and a borane group that is ideally represented by —BR³R⁴.

Here, R¹ and R² each represent, independently, a hydrogen atom or an alkyl group of 1 to 6 carbon atoms, which may be either substituted or unsubstituted. However, R¹ and R² cannot both be hydrogen atoms.

Furthermore, R³ and R⁴ each represent, independently, an alkyl group of 1 to 6 carbon atoms, which may be either substituted or unsubstituted.

R⁵ is a bivalent hydrocarbon group that eventually forms an ester ring comprising a 5-membered or 6-membered ring. This bivalent hydrocarbon group may be either substituted or unsubstituted. Examples of suitable bivalent hydrocarbon groups for the group R⁵ include alkylene groups of 2 or 3 carbon atoms, and ortho- or meta-phenylene groups. These alkylene groups and ortho- or meta-phenylene groups may be either substituted or unsubstituted.

An ideal boronate ester group includes a functional group generated by an esterification reaction between a monovalent alcohol of 1 to 6 carbon atoms, an ethanediol such as pinacol, a propanediol or an ortho-aromatic diol such as 1,2-dihydroxybenzene, and a boronic acid group.

Examples of preferred functional groups capable of a coupling reaction with the boron derivative functional group include reactive halide functional groups. Examples of reactive halide functional groups include —Cl, —Br or —I, as well as a triflate group (CF₃SO₃—). Other possible groups besides these reactive halide functional groups include a tosylate group or a mesylate group.

In the following description, functional groups capable of initiating a coupling reaction with the boron derivative functional group are also referred to as “reactive halide functional groups or the like”.

Preferred embodiments of the Suzuki coupling reaction are described below.

A first embodiment is a polymerization of a first monomer containing two boron derivative functional groups, and a second monomer containing two reactive halide functional groups or the like. The first and second monomers may be either the same monomer or different monomers. If the first and second monomers are the same monomer, then a homopolymer is produced. If the first and second monomers are different, then a copolymer is produced. Furthermore, a plurality of different monomers can be used as the first monomer or the second monomer.

A second embodiment is a polymerization of a monomer containing a single boron derivative functional group and a single reactive halide functional group or the like, and typically results in the production of a homopolymer. Furthermore, a copolymer can also be obtained by using a plurality of different monomers.

Examples of other embodiments include an embodiment that uses a monomer containing three or more boron derivative functional groups, and a monomer containing three or more reactive halide functional groups or the like.

The reaction solvent is preferably capable of dissolving the conjugated polymer. For example, in those cases where the conjugated polymer is a polyfluorene derivative or poly(p-phenylene) derivative, a non-polar aromatic solvent such as toluene, anisole, benzene, ethylbenzene, mesitylene or xylene can be used, and toluene and anisole are preferred. The monomer concentration is preferably within a range from 0.01 to 0.5 mol/l, and is even more preferably from 0.05 to 0.2 mol/l. These numerical values are determined for the total number of mols of the monomer(s) used.

A catalyst is normally used in the process for producing a conjugated polymer according to the present invention. The catalyst used is preferably a palladium catalyst. The palladium catalyst may be either a Pd(0) complex or a Pd(II) complex. Furthermore, Pd(II) salts can also be used. Specific examples of suitable Pd catalysts include tetrakis(triphenylphosphine) palladium, tetrakis(tri-o-tolylphosphine) palladium, tetrakis(tri-tert-butylphosphine) palladium, bis(1,2-bis(diphenylphosphino)ethane) palladium, bis(1,1′-bis(diphenylphosphino)ferrocene) palladium, tetrakis(triethyl phosphite) palladium, dichlorobis(triphenylphosphine) palladium, dichlorobis(tri-tert-butylphosphine) palladium, and [1,1′-bis(diphenylphosphino)ferrocene] palladium(II) chloride. Atypical quantity for the palladium catalyst is within a range from 0.01 to 5 mol %, and a quantity from approximately 0.05 to 0.2 mol % is preferred. These numerical values are determined relative to the total number of mols of the monomer(s) used.

In the process for producing a conjugated polymer according to the present invention, the use of an inorganic base is preferred. Examples of suitable inorganic bases include sodium carbonate, potassium carbonate, cesium carbonate, and potassium phosphate. Furthermore, these inorganic bases are preferably used in the form of aqueous solutions, such as a 1M to 2M aqueous solution of potassium carbonate. The quantity of the base should be greater than the total number of mols of monomer, and is preferably sufficient to provide a molar ratio, relative to the monomer containing the reactive halide functional group, of at least 5-fold, and even more preferably 10-fold or greater.

In the process for producing a conjugated polymer according to the present invention, the use of a phase transfer catalyst is preferred. Examples of suitable phase transfer catalysts include tetraalkylammonium halides, tetraalkylammonium bisulfates, and tetraalkylammonium hydroxides. A specific example is tricaprylmethylammonium chloride. The quantity of the phase transfer catalyst is preferably within a range from 1 to 5 vol % relative to the toluene or anisole reaction solvent, and a quantity of approximately 3 vol % is even more preferred.

The production process of the present invention is a process for producing a conjugated polymer by Suzuki coupling, wherein the process uses microwave irradiation. Specifically, in the production process of the present invention, the Suzuki coupling reaction is conducted under microwave irradiation.

The microwaves preferably have a frequency within a range from 300 MHz to 300 GHz, and usually the 2,450 MHz band is used.

A commercially available microwave irradiation apparatus can be used as the microwave irradiation apparatus. Microwave irradiation apparatus are available commercially, for example, from Milestone General Co., Ltd. or Astech Corporation. In the examples of the present invention, an apparatus manufactured by Milestone General Co., Ltd. (MicroSYNTH, a microwave synthetic reaction apparatus, frequency: 2,450 MHz, maximum output: 1,000 W) was used, but the present invention is not limited to this apparatus.

Furthermore, because the reaction solution, and particularly basic aqueous solutions, absorb microwaves rapidly, meaning there is a danger of bumping, the reaction vessel is preferably a pressure-resistant closed vessel.

There are no particular restrictions on the reaction temperature, which may be any temperature that enables a conjugated polymer to be obtained, although a temperature within a range from 70 to 150° C. is preferred, and a temperature from 90 to 110° C. is even more desirable. If the reaction temperature is too low, then the polymerization tends to proceed poorly, whereas if the reaction temperature is too high, side-reactions become more prevalent, and the purified polymer tends to become more intensely colored. The time taken to reach the reaction temperature is preferably within a range from several minutes to 30 minutes.

The reaction time is preferably within a range from 10 to 240 minutes, and is even more preferably from 30 to 120 minutes. If the reaction time is too short, then the progress of the polymerization tends to be inadequate, whereas if the reaction time is too long, side-reactions become more prevalent, and the purified polymer tends to become more intensely colored. If required the reaction time may be shortened to less than 10 minutes or lengthened to longer than 240 minutes. The microwave irradiation may be conducted continuously for the entire reaction time, or may be conducted only during a specific portion of the reaction time. Moreover, the irradiation may also be conducted intermittently, with ongoing regulation of the temperature or the like.

The microwave maximum output is preferably in keeping with a temperature program. This maximum output varies depending on the quantities of monomer and solvent and the like, but is preferably within a range from 100 to 500 W.

Specific examples of the conjugated polymer obtained using the production process of the present invention include polymers that include, as the main backbone, a poly(arylene) such as polyphenylene, polyfluorene, polyphenanthrene or polypyrene, or a derivative thereof, a poly(heteroarylene) such as polythiophene, polyquinoline or polycarbazole, or a derivative thereof, a poly(arylenevinylene) or a derivative thereof, or a poly(aryleneethynylene) or a derivative thereof. Further examples include polymers that include, as a unit (that is, a structure that need not necessarily exist within the main backbone, and may be a side chain structure), a structure such as benzene, naphthalene, anthracene, phenanthrene, chrysene, rubrene, pyrene, perylene, indene, azulene, adamantane, fluorene, fluorenone, dibenzofuran, carbazole, dibenzothiophene, furan, pyrrole, pyrroline, pyrrolidine, thiophene, dioxolane, pyrazole, pyrazoline, pyrazolidine, imidazole, oxazole, thiazole, oxadiazole, triazole, thiadiazole, pyran, pyridine, piperidine, dioxane, morpholine, pyridazine, pyrimidine, pyrazine, piperazine, triazine, trithiane, norbornene, benzofuran, indole, benzothiophene, benzimidazole, benzoxazole, benzothiazole, benzothiadiazole, benzoxadiazole, purine, quinoline, isoquinoline, coumarin, cinnoline, quinoxaline, acridine, phenanthroline, phenothiazine, flavone, triphenylamine, acetylacetone, dibenzoylmethane, picolinic acid, silole, porphyrin or a coordination compound of a metal such as iridium, or a derivative thereof.

In the present invention, polymers that include, as the main backbone, a poly(arylene) or derivative thereof, or a poly(heteroarylene) or derivative thereof are particularly preferred. Furthermore, polymers that include, as a unit, a structure of benzene, naphthalene, anthracene, phenanthrene, pyrene, fluorene, dibenzofuran, carbazole, dibenzothiophene, furan, thiophene, oxadiazole, triazole, thiadiazole, pyridine, triazine, benzothiophene, benzimidazole, benzoxazole, benzothiazole, benzothiadiazole, benzoxadiazole, quinoline, isoquinoline, acridine, phenanthroline, triphenylamine, acetylacetone, dibenzoylmethane, or a coordination compound of a metal such as iridium, or a derivative thereof are also preferred.

In the present invention, the weight average molecular weight of the conjugated polymer is preferably within a range from 1,000 to 1,000,000, is even more preferably from 10,000 to 1,000,000, and is most preferably from 30,000 to 800,000. This weight average molecular weight described above refers to the weight average molecular weight measured using gel permeation chromatography and referenced against polystyrene standards.

The conjugated polymer obtained using the production process of the present invention can be used as an organic electronics material such as an electroluminescent material, an electrochromic material, a laser material, a material for an electronic device such as a diode, transistor or FET, a solar cell material, or a sensor material. A conjugated polymer obtained using the production process of the present invention can be used particularly favorably as an electroluminescent material. Specifically, the conjugated polymer can be used as a light-emitting layer, an electron or positive hole injection layer, an electron or positive hole transport layer, or an electron or positive hole blocking layer.

In the present invention, an electroluminescent device can also be obtained by using the conjugated polymer as an electroluminescent material. There are no particular restrictions on the general structure of the electroluminescent device, and examples include the structures disclosed in U.S. Pat. No. 4,539,507 and U.S. Pat. No. 5,151,629. Furthermore, a polymer-containing electroluminescent device is disclosed, for example, in International Patent Publication WO90/13148 and European Patent Publication EP-A-0443861.

These usually include an electroluminescent layer (light-emitting layer) between cathode and anode electrodes, at least one of which is transparent. Furthermore, one or more electron injection layers, electron transport layers and/or positive hole blocking layers can be inserted between the electroluminescent layer (light-emitting layer) and the cathode. Moreover, one or more positive hole injection layers, positive hole transport layers and/or electron blocking layers can be inserted between the electroluminescent layer (light-emitting layer) and the anode. The cathode material is preferably a metal or metal alloy, such as Li, Ca, Ba, Mg, Al, In, Cs, Mg/Ag, or LiF. The anode material can use a metal (such as Au) or another material having metallic conductivity such as, for example, an oxide (such as ITO: indium oxide/tin oxide), formed on a transparent substrate (such as glass or a transparent polymer).

As described above, the production process of the present invention may be applied not only to electroluminescent materials used in light-emitting layers, but also to the electroluminescent materials used in any of the normal layers within an aforementioned electroluminescent device.

In the present invention, in order to use the conjugated polymer within an electroluminescent device, a solution containing either a single polymer or a polymer mixture is layered onto a substrate using any conventional method known to those skilled in the art, such as an inkjet method, casting method, immersion method, printing method or spin coating method. Furthermore, the conjugated polymer can also be laminated to the substrate in a solid state such as a film, by using a lamination method or the like. The layering method is not limited to the methods listed above. The above types of layering methods are typically conducted at a temperature within a range from −20 to +300° C., preferably from 10 to 100° C., and even more preferably from 15 to 50° C. Furthermore, drying of the applied polymer solution is typically conducted by room temperature drying, or heated drying using a hotplate.

Examples of solvents that can be used in forming the solution include chloroform, methylene chloride, dichloroethane, tetrahydrofuran, toluene, xylene, mesitylene, anisole, acetone, methyl ethyl ketone, ethyl acetate, butyl acetate and ethyl cellosolve acetate.

As is evident from the examples and comparative examples, the process for producing a conjugated polymer according to the present invention is a superior method that enables significant shortening of the reaction time. Furthermore, the process for producing a conjugated polymer according to the present invention is ideal for producing an electroluminescent material and an electroluminescent device that exhibit excellent light-emitting properties.

Because the production process of the present invention enables a dramatic shortening of the reaction time, decomposition of the catalyst does not occur, and discoloration of the polymer product can be prevented. Moreover, an organic EL device that uses a conjugated polymer obtained using the production process of the present invention exhibits superior levels of luminance, power efficiency and lifetime to organic EL devices that use conventional conjugated polymers.

### EXAMPLES

A more detailed description of the present invention is presented below using a series of examples, but the present invention is in no way limited by the following examples.

### Examples 1 to 16

### Polymer Synthesis (1)

Reaction was conducted using a special-purpose polytetrafluoroethylene reaction vessel. The solvent was subjected to a treatment in which nitrogen gas was bubbled through the solvent for at least 30 minutes to remove oxygen prior to use. The reaction vessel was charged with 2,7-dibromo-9,9-dioctylfluorene (P9) (0.4 mmol) and the diboronate ester of 9,9-dioctylfluorene (B13) (0.4 mmol), and with the vessel placed in a glove box under an atmosphere of nitrogen, a 3 vol % toluene or anisole solution of tricaprylmethylammonium chloride (8 ml, see Table 1) and a 8 mM toluene or anisole solution of Pd(PPh₃)₄ (see Table 1) were then added to the vessel, thus yielding a mixture. Following stirring of the mixture to dissolve the monomers, a 2M aqueous base (5.3 ml, see Table 1) was added. The reaction vessel was then mounted in a microwave irradiation apparatus, and with the reaction mixture undergoing constant stirring, a Suzuki coupling reaction was conducted under the microwave irradiation conditions shown in Table 2. The mixture comprising all of the reagents and solvents other than the monomers was used as a reference for controlling the temperature. Following completion of the reaction, the reaction mixture was poured into methanol-water (volumetric ratio (this also applies to all subsequent ratios) 9:1) (150 ml). The generated precipitate was isolated by suction filtration and then washed in methanol-water (9:1). The thus obtained precipitate was then re-dissolved in toluene or anisole, and re-precipitated from methanol-acetone (8:3) (90 ml). The thus obtained precipitate was isolated by suction filtration and then washed in methanol-acetone (8:3). The precipitate was then once again re-precipitated from methanol-acetone (8:3), yielding a crude polyfluorene product. The crude polyfluorene was dissolved in toluene (10 ml per 100 mg of the polymer), a polystyrene-bound phosphorus product (triphenylphosphine, polymer-bound on styrene-divinylbenzene copolymer, STREM Chemicals, Inc., 15-6730, 200 mg per 100 mg of the polymer) was added, and the resulting mixture was stirred overnight. Following completion of the stirring, the polystyrene-bound phosphorus product was removed by filtration, and the filtrate was concentrated using a rotary evaporator. The residue was dissolved in toluene, and then re-precipitated from methanol-acetone (8:3). The generated precipitate was isolated by suction filtration and then washed in methanol-acetone (8:3). The thus obtained precipitate was then vacuum dried, yielding a conjugated polymer (see Table 3 for yield and molecular weight). The molecular weight was measured by GPC (against polystyrene standards) using THF as the eluent.

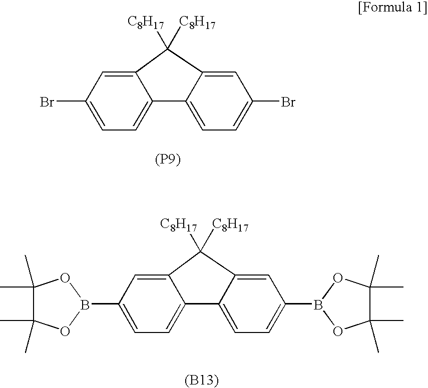

### Comparative Example 1

With the exceptions of using a typical glass vessel instead of the special-purpose reaction vessel, and conducting a typical reaction over 48 hours at 95° C. instead of using the microwave reaction, synthesis was conducted in the same manner as the example 1, yielding a conjugated polymer (see Table 3 for yield and molecular weight).

TABLE 1

| | Pd(PPh₃)₄ | | |
|---|---|---|---|
| | (mmol) | Solvent | Base |
| Example 1 | 0.008 | toluene | K₂CO₃ |
| Example 2 | 0.008 | toluene | K₂CO₃ |
| Example 3 | 0.008 | toluene | K₂CO₃ |
| Example 4 | 0.008 | toluene | K₂CO₃ |
| Example 5 | 0.008 | toluene | K₂CO₃ |
| Example 6 | 0.004 | toluene | K₂CO₃ |
| Example 7 | 0.002 | toluene | K₂CO₃ |
| Example 8 | 0.001 | toluene | K₂CO₃ |
| Example 9 | 0.004 | toluene | Na₂CO₃ |
| Example 10 | 0.004 | toluene | Cs₂CO₃ |
| Example 11 | 0.004 | toluene | K₃PO₄ |
| Example 12 | 0.002 | anisole | K₂CO₃ |
| Example 13 | 0.002 | anisole | Cs₂CO₃ |
| Example 14 | 0.002 | anisole | K₃PO₄ |
| Example 15 | 0.0008 | anisole | K₂CO₃ |
| Example 16 | 0.0004 | anisole | K₂CO₃ |
| Comparative | 0.008 | toluene | K₂CO₃ |
| example 1 | | | |

TABLE 2

| | | | Microwave |
|---|---|---|---|
| | Temperature program | Temperature program | maximum |
| | 1 | 2 | output (W) |
| Example 1 | Room temperature → | 130° C./120 minutes | 300 |
| | 130° C./10 minutes | | |
| Example 2 | Room temperature → | 110° C./60 minutes | 300 |
| | 110° C./10 minutes | | |
| Example 3 | Room temperature → | 110° C./120 minutes | 300 |
| | 110° C./10 minutes | | |
| Example 4 | Room temperature → | 90° C./60 minutes | 300 |
| | 90° C./10 minutes | | |
| Example 5 | Room temperature → | 90° C./120 minutes | 300 |
| | 90° C./10 minutes | | |
| Examples | Room temperature → | 90° C./120 minutes | 300 |
| 6 to 16 | 90° C./10 minutes | | |

TABLE 3

| | | | Molecular weight |
|---|---|---|---|
| | Yield | Molecular weight | distribution |
| | (g) | (Mw) | (Mw/Mn) |
| Example 1 | 0.21 | 21,900 | 2.74 |
| Example 2 | 0.19 | 23,600 | 2.84 |
| Example 3 | 0.21 | 22,800 | 2.86 |
| Example 4 | 0.18 | 22,600 | 2.65 |
| Example 5 | 0.25 | 44,200 | 2.76 |
| Example 6 | 0.24 | 77,900 | 2.60 |
| Example 7 | 0.27 | 123,200 | 2.95 |
| Example 8 | 0.28 | 131,500 | 2.59 |
| Example 9 | 0.26 | 75,900 | 2.83 |
| Example 10 | 0.27 | 76,700 | 2.87 |
| Example 11 | 0.27 | 83,700 | 2.79 |
| Example 12 | 0.28 | 133,500 | 3.09 |
| Example 13 | 0.27 | 130,700 | 2.95 |
| Example 14 | 0.27 | 130,400 | 2.97 |
| Example 15 | 0.22 | 135,800 | 2.83 |
| Example 16 | 0.24 | 150,100 | 2.62 |
| Comparative | 0.21 | 43,100 | 2.64 |
| example 1 | | | |

### Examples 17 to 24

### Polymer Synthesis (2)

Reaction was conducted using a special-purpose polytetrafluoroethylene reaction vessel. The solvent was subjected to a treatment in which nitrogen gas was bubbled through the solvent for at least 30 minutes to remove oxygen prior to use. The reaction vessel was charged with 4,7-dibromo-2,1,3-benzothiazole (R5) (0.08 mmol), 4,4′-dibromotriphenylamine (R12) (0.32 mmol) and the diboronate ester of 9,9-dioctylfluorene (B13) (0.4 mmol), and with the vessel placed in a glove box under an atmosphere of nitrogen, a 3 vol % toluene or anisole solution of tricaprylmethylammonium chloride (8 ml, see Table 4) and a 8 mM toluene or anisole solution of Pd(PPh₃)₄ (see Table 4) were then added to the vessel, thus yielding a mixture. Following stirring of the mixture to dissolve the monomers, a 2M aqueous solution of K₂CO₃ (5.3 ml) was added. The reaction vessel was then mounted in a microwave irradiation apparatus, and with the reaction mixture undergoing constant stirring, a Suzuki coupling reaction was conducted under the microwave irradiation conditions shown in Table 5. Following completion of the reaction, the reaction mixture was poured into methanol-water (9:1) (150 ml). The generated precipitate was isolated by suction filtration and then washed in methanol-water (9:1). The thus obtained precipitate was then re-dissolved in toluene or anisole, and re-precipitated from methanol-acetone (8:3) (90 ml). The thus obtained precipitate was isolated by suction filtration and then washed in methanol-acetone (8:3). The precipitate was then once again re-precipitated from methanol-acetone (8:3), yielding a crude product. The crude product was dissolved in toluene (10 ml per 100 mg of the polymer), a polystyrene-bound phosphorus product (triphenylphosphine, polymer-bound on styrene-divinylbenzene copolymer, STREM Chemicals, Inc., 15-6730, 200 mg per 100 mg of the polymer) was added, and the resulting mixture was stirred overnight. Following completion of the stirring, the polystyrene-bound phosphorus product was removed by filtration, and the filtrate was concentrated using a rotary evaporator. The residue was dissolved in toluene, and then re-precipitated from methanol-acetone (8:3). The generated precipitate was isolated by suction filtration and then washed in methanol-acetone (8:3). The thus obtained precipitate was then vacuum dried, yielding a conjugated polymer (see Table 6 for yield and molecular weight). The molecular weight was measured by GPC (against polystyrene standards) using THF as the eluent.

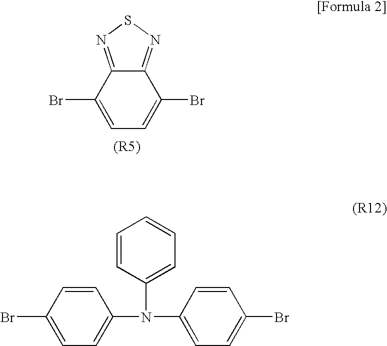

### Comparative Example 2

With the exceptions of using a typical glass vessel instead of the special-purpose reaction vessel, and conducting a typical reaction over 48 hours at 95° C. instead of using the microwave reaction, synthesis was conducted in the same manner as the example 17, yielding a conjugated polymer (see Table 6 for yield and molecular weight).

TABLE 4

| | Pd(PPh₃)₄ | |
|---|---|---|
| | (mmol) | Solvent |
| Example 17 | 0.008 | toluene |
| Example 18 | 0.004 | toluene |
| Example 19 | 0.002 | toluene |
| Example 20 | 0.001 | toluene |
| Example 21 | 0.0008 | toluene |
| Example 22 | 0.00016 | toluene |
| Example 23 | 0.0008 | anisole |
| Example 24 | 0.0004 | anisole |
| Comparative example 2 | 0.008 | toluene |

TABLE 5

| | | | Microwave |
|---|---|---|---|
| | Temperature program | Temperature program | maximum |
| | 1 | 2 | output (W) |
| Examples | Room temperature → | 90° C./120 minutes | 300 |
| 17 to 24 | 90° C./10 minutes | | |

TABLE 6

| | | | Molecular weight |
|---|---|---|---|
| | Yield | Molecular weight | distribution |
| | (g) | (Mw) | (Mw/Mn) |
| Example 17 | 0.20 | 27,500 | 2.59 |
| Example 18 | 0.21 | 35,000 | 2.57 |
| Example 19 | 0.22 | 51,100 | 2.43 |
| Example 20 | 0.22 | 60,300 | 2.37 |
| Example 21 | 0.21 | 36,900 | 2.27 |
| Example 22 | 0.21 | 35,600 | 2.08 |
| Example 23 | 0.22 | 56,400 | 2.24 |
| Example 24 | 0.22 | 63,000 | 2.26 |
| Comparative | 0.20 | 20,100 | 2.16 |
| example 2 | | | |

### Example 25

### Polymer Synthesis (3)

Reaction was conducted using a special-purpose polytetrafluoroethylene reaction vessel. The solvent was subjected to a treatment in which nitrogen gas was bubbled through the solvent for at least 30 minutes to remove oxygen prior to use. The reaction vessel was charged with a benzotriazole derivative (R271) (0.4 mmol) and the diboronate ester of 9,9-dioctylfluorene (B13) (0.4 mmol), and with the vessel placed in a glove box under an atmosphere of nitrogen, a 3% toluene solution of tricaprylmethylammonium chloride (8 ml) and a 8 mM toluene solution of Pd(PPh₃)₄ (0.008 mmol) were then added to the vessel, thus yielding a mixture. Following stirring of the mixture to dissolve the monomers, a 2M aqueous solution of K₂CO₃ (5.3 ml) was added. The reaction vessel was then mounted in a microwave irradiation apparatus, and with the reaction mixture undergoing constant stirring, a Suzuki coupling reaction was conducted under the microwave irradiation conditions shown in Table 7. Following completion of the reaction, the reaction mixture was poured into methanol-water (9:1) (150 ml). The generated precipitate was isolated by suction filtration and then washed in methanol-water (9:1). The thus obtained precipitate was then re-dissolved in toluene, and re-precipitated from methanol-acetone (8:3) (90 ml). The thus obtained precipitate was isolated by suction filtration and then washed in methanol-acetone (8:3). The precipitate was then once again re-precipitated from methanol-acetone (8:3), yielding a crude product. The crude product was dissolved in toluene (10 ml per 100 mg of the polymer), a polystyrene-bound phosphorus product (triphenylphosphine, polymer-bound on styrene-divinylbenzene copolymer, STREM Chemicals, Inc., 15-6730, 200 mg per 100 mg of the polymer) was added, and the resulting mixture was stirred overnight. Following completion of the stirring, the polystyrene-bound phosphorus product was removed by filtration, and the filtrate was concentrated using a rotary evaporator. The residue was dissolved in toluene, and then re-precipitated from methanol-acetone (8:3). The generated precipitate was isolated by suction filtration and then washed in methanol-acetone (8:3). The thus obtained precipitate was then vacuum dried, yielding a conjugated polymer (see Table 8 for yield and molecular weight). The molecular weight was measured by GPC (against polystyrene standards) using THF as the eluent.

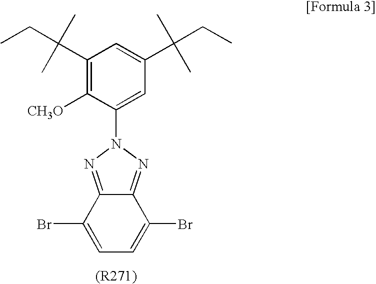

### Comparative Example 3

With the exceptions of using a typical glass vessel instead of the special-purpose reaction vessel, and conducting a typical reaction over 48 hours at 95° C. instead of using the microwave reaction, synthesis was conducted in the same manner as the example 25, yielding a conjugated polymer (see Table 8 for yield and molecular weight).

TABLE 7

| | | | Microwave |
|---|---|---|---|
| | Temperature program | Temperature program | maximum |
| | 1 | 2 | output (W) |
| Example | Room temperature → | 90° C./120 minutes | 300 |
| 25 | 90° C./10 minutes | | |

TABLE 8

| | | | Molecular weight |
|---|---|---|---|
| | Yield | Molecular weight | distribution |
| | (g) | (Mw) | (Mw/Mn) |
| Example 25 | 0.25 | 96,800 | 2.32 |
| Comparative | 0.23 | 62,900 | 2.28 |
| example 3 | | | |

### Examples 26 to 88

Reaction was conducted using a special-purpose polytetrafluoroethylene reaction vessel. The solvent was subjected to a treatment in which nitrogen gas was bubbled through the solvent for at least 30 minutes to remove oxygen prior to use. The reaction vessel was charged with the dibromo monomer(s) and the diboronate ester monomer shown in Table 9, and with the vessel placed in a glove box under an atmosphere of nitrogen, a 3 vol % anisole solution of tricaprylmethylammonium chloride (8 ml) and a 8 mM anisole solution of Pd(PPh₃)₄ (100 μl) were then added to the vessel, thus yielding a mixture. Following stirring of the mixture to dissolve the monomers, a 2M aqueous solution of K₂CO₃ (5.3 ml) was added. The reaction vessel was then mounted in a microwave irradiation apparatus, and with the reaction mixture undergoing constant stirring, a Suzuki coupling reaction was conducted under the microwave irradiation conditions shown in Table 10. Following completion of the reaction, the reaction mixture was poured into methanol-water (9:1) (150 ml). The generated precipitate was isolated by suction filtration and then washed in methanol-water (9:1). The thus obtained precipitate was then re-dissolved in anisole, and re-precipitated from methanol-acetone (8:3) (90 ml). The thus obtained precipitate was isolated by suction filtration and then washed in methanol-acetone (8:3). The precipitate was then once again re-precipitated from methanol-acetone (8:3), yielding a crude product. The crude product was dissolved in toluene (10 ml per 100 mg of the polymer), a polystyrene-bound phosphorus product (triphenylphosphine, polymer-bound on styrene-divinylbenzene copolymer, STREM Chemicals, Inc., 15-6730, 200 mg per 100 mg of the polymer) was added, and the resulting mixture was stirred overnight. Following completion of the stirring, the polystyrene-bound phosphorus product was removed by filtration, and the filtrate was concentrated using a rotary evaporator. The residue was dissolved in toluene, and then re-precipitated from methanol-acetone (8:3). The generated precipitate was isolated by suction filtration and then washed in methanol-acetone (8:3). The thus obtained precipitate was then vacuum dried, yielding a conjugated polymer (see Table 11 for yield and molecular weight). The molecular weight was measured by GPC (against polystyrene standards) using THF as the eluent.

TABLE 9

| | Monomer 1 | Monomer 2 | Monomer 3 | Monomer 4 |
|---|---|---|---|---|
| | (mmol) | (mmol) | (mmol) | (mmol) |
| Example 26 | B13 | P34 | | |
| | (0.4) | (0.4) | | |
| Example 27 | B13 | P35 | | |
| | (0.4) | (0.4) | | |
| Example 28 | B13 | PH7 | | |
| | (0.4) | (0.4) | | |
| Example 29 | B13 | PH9 | | |
| | (0.4) | (0.4) | | |
| Example 30 | B13 | R5 | | |
| | (0.4) | (0.4) | | |
| Example 31 | B13 | R7 | | |
| | (0.4) | (0.4) | | |
| Example 32 | B13 | R12 | | |
| | (0.4) | (0.4) | | |
| Example 33 | B13 | R271 | | |
| | (0.4) | (0.4) | | |
| Example 34 | B13 | R43 | | |
| | (0.4) | (0.4) | | |
| Example 35 | B13 | RH6 | | |
| | (0.4) | (0.4) | | |
| Example 36 | BH5 | P12 | | |
| | (0.4) | (0.4) | | |
| Example 37 | BH5 | P34 | | |
| | (0.4) | (0.4) | | |
| Example 38 | BH5 | P35 | | |
| | (0.4) | (0.4) | | |
| Example 39 | BH5 | PH7 | | |
| | (0.4) | (0.4) | | |
| Example 40 | BH5 | PH9 | | |
| | (0.4) | (0.4) | | |
| Example 41 | BH5 | R5 | | |
| | (0.4) | (0.4) | | |
| Example 42 | BH5 | R7 | | |
| | (0.4) | (0.4) | | |
| Example 43 | BH5 | R12 | | |
| | (0.4) | (0.4) | | |
| Example 44 | BH5 | R271 | | |
| | (0.4) | (0.4) | | |
| Example 45 | BH5 | RH6 | | |
| | (0.4) | (0.4) | | |
| Example 46 | BH11 | P9 | | |
| | (0.4) | (0.4) | | |
| Example 47 | BH11 | P12 | | |
| | (0.4) | (0.4) | | |
| Example 48 | BH11 | P34 | | |
| | (0.4) | (0.4) | | |
| Example 49 | BH11 | P35 | | |
| | (0.4) | (0.4) | | |
| Example 50 | BH11 | PH7 | | |
| | (0.4) | (0.4) | | |
| Example 51 | BH11 | PH9 | | |
| | (0.4) | (0.4) | | |
| Example 52 | BH11 | R5 | | |
| | (0.4) | (0.4) | | |
| Example 53 | BH11 | R12 | | |
| | (0.4) | (0.4) | | |
| Example 54 | BH11 | R271 | | |
| | (0.4) | (0.4) | | |
| Example 55 | BH1 | P9 | | |
| | (0.4) | (0.4) | | |
| Example 56 | BH1 | P12 | | |
| | (0.4) | (0.4) | | |
| Example 57 | BH1 | P34 | | |
| | (0.4) | (0.4) | | |
| Example 58 | BH1 | P35 | | |
| | (0.4) | (0.4) | | |
| Example 59 | BH1 | PH7 | | |
| | (0.4) | (0.4) | | |
| Example 60 | BH1 | PH9 | | |
| | (0.4) | (0.4) | | |
| Example 61 | BH1 | R5 | | |
| | (0.4) | (0.4) | | |
| Example 62 | BH1 | R12 | | |
| | (0.4) | (0.4) | | |
| Example 63 | BH1 | R271 | | |
| | (0.4) | (0.4) | | |
| Example 64 | B13 | R12 | R15 | |
| | (0.4) | (0.2) | (0.2) | |
| Example 65 | B13 | P9 | R12 | R15 |
| | (0.4) | (0.2) | (0.1) | (0.1) |
| Example 66 | B13 | R12 | R271 | |
| | (0.4) | (0.2) | (0.2) | |
| Example 67 | B13 | P9 | R12 | R271 |
| | (0.4) | (0.2) | (0.16) | (0.04) |
| Example 68 | B13 | R12 | R23 | |
| | (0.4) | (0.2) | (0.2) | |
| Example 69 | B13 | P9 | R12 | R23 |
| | (0.4) | (0.2) | (0.1) | (0.1) |
| Example 70 | B13 | P9 | Porl | |
| | (0.4) | (0.32) | (0.08) | |
| Example 71 | B13 | R12 | R15 | L3 |
| | (0.4) | (0.22) | (0.14) | (0.04) |
| Example 72 | BH5 | R12 | R15 | |
| | (0.4) | (0.2) | (0.2) | |
| Example 73 | BH5 | P12 | R12 | R15 |
| | (0.4) | (0.2) | (0.1) | (0.1) |
| Example 74 | BH5 | R12 | R271 | |
| | (0.4) | (0.2) | (0.2) | |
| Example 75 | BH5 | P12 | R12 | R271 |
| | (0.4) | (0.2) | (0.16) | (0.04) |
| Example 76 | BH5 | R12 | R23 | |
| | (0.4) | (0.2) | (0.2) | |
| Example 77 | BH5 | P12 | R12 | R23 |
| | (0.4) | (0.2) | (0.1) | (0.1) |
| Example 78 | BH5 | R12 | R15 | L3 |
| | (0.4) | (0.22) | (0.14) | (0.04) |
| Example 79 | BH5 | P12 | Porl | |
| | (0.4) | (0.32) | (0.08) | |
| Example 80 | BH11 | R12 | R15 | |
| | (0.4) | (0.2) | (0.2) | |
| Example 81 | BH11 | PH7 | R12 | R15 |
| | (0.4) | (0.2) | (0.1) | (0.1) |
| Example 82 | BH11 | R12 | R271 | |
| | (0.4) | (0.2) | (0.2) | |
| Example 83 | BH11 | PH7 | R12 | R271 |
| | (0.4) | (0.2) | (0.16) | (0.04) |
| Example 84 | BH11 | R12 | R23 | |
| | (0.4) | (0.2) | (0.2) | |
| Example 85 | BH11 | PH7 | R12 | R23 |
| | (0.4) | (0.2) | (0.1) | (0.1) |
| Example 86 | BH13 | BH10 | PH7 | R271 |
| | (0.32) | (0.08) | (0.36) | (0.04) |
| Example 87 | BH13 | BH10 | PH7 | R5 |
| | (0.32) | (0.08) | (0.32) | (0.08) |
| Example 88 | BH13 | BH10 | PH7 | R15 |
| | (0.32) | (0.08) | (0.32) | (0.08) |

[Formula 4]

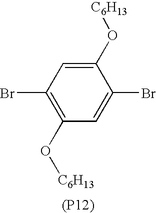

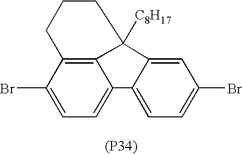

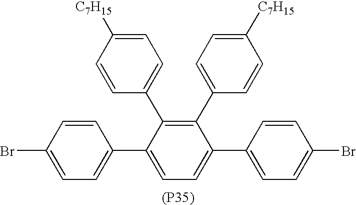

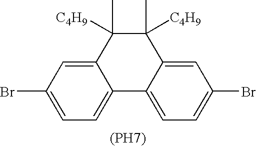

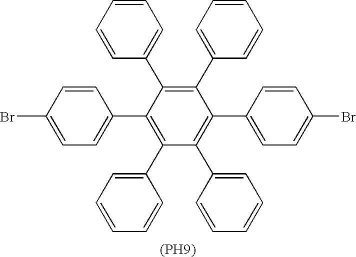

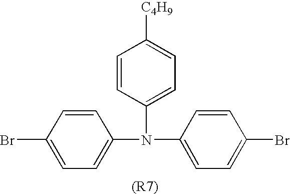

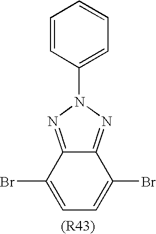

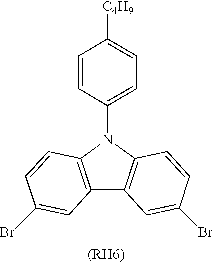

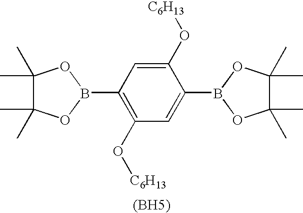

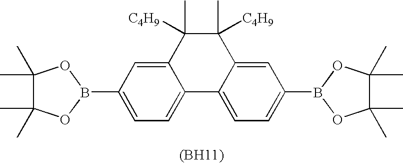

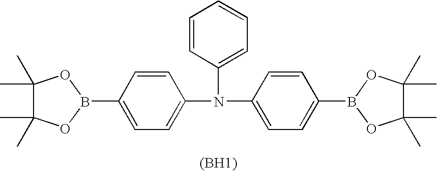

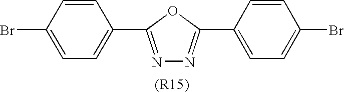

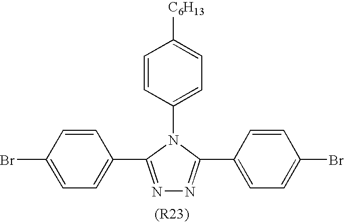

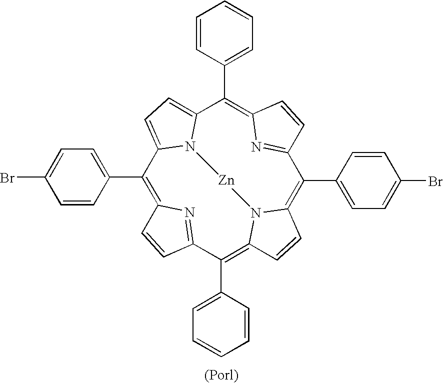

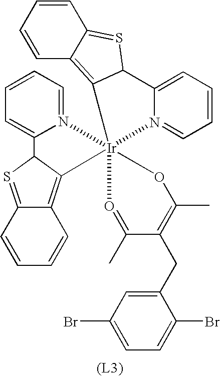

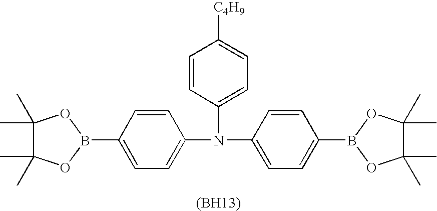

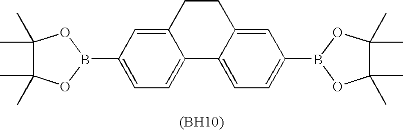

TABLE 10

| | | | Microwave |
|---|---|---|---|
| | Temperature program | Temperature program | maximum |
| | 1 | 2 | output (W) |
| Examples | Room temperature → | 90° C./120 minutes | 300 |
| 26 to 88 | 90° C./10 minutes | | |

TABLE 11

| | | | Molecular weight |
|---|---|---|---|
| | Yield | Molecular weight | distribution |
| | (g) | (Mw) | (Mw/Mn) |
| Example 26 | 0.18 | 37,800 | 2.42 |
| Example 27 | 0.21 | 49,000 | 2.50 |
| Example 28 | 0.23 | 75,200 | 2.41 |
| Example 29 | 0.22 | 63,400 | 2.43 |
| Example 30 | 0.24 | 112,200 | 2.48 |
| Example 31 | 0.24 | 64,100 | 2.38 |
| Example 32 | 0.22 | 59,000 | 2.50 |
| Example 33 | 0.21 | 104,000 | 2.23 |
| Example 34 | 0.22 | 211,500 | 4.86 |
| Example 35 | 0.17 | 33,600 | 2.26 |
| Example 36 | 0.20 | 45,500 | 2.22 |
| Example 37 | 0.19 | 36,500 | 2.21 |
| Example 38 | 0.19 | 38,800 | 2.24 |
| Example 39 | 0.21 | 42,600 | 2.31 |
| Example 40 | 0.22 | 38,700 | 2.29 |
| Example 41 | 0.21 | 51,400 | 2.38 |
| Example 42 | 0.21 | 50,900 | 2.47 |
| Example 43 | 0.18 | 45,300 | 2.77 |
| Example 44 | 0.19 | 61,900 | 2.54 |
| Example 45 | 0.20 | 30,200 | 2.23 |
| Example 46 | 0.22 | 65,500 | 2.36 |
| Example 47 | 0.22 | 42,900 | 2.32 |
| Example 48 | 0.20 | 39,700 | 2.29 |
| Example 49 | 0.19 | 37,700 | 2.31 |
| Example 50 | 0.18 | 40,100 | 2.33 |
| Example 51 | 0.21 | 53,700 | 2.42 |
| Example 52 | 0.22 | 82,500 | 2.51 |
| Example 53 | 0.22 | 47,200 | 2.38 |
| Example 54 | 0.24 | 90,200 | 2.41 |
| Example 55 | 0.19 | 42,800 | 2.18 |
| Example 56 | 0.20 | 37,700 | 2.27 |
| Example 57 | 0.17 | 29,600 | 2.19 |
| Example 58 | 0.19 | 32,600 | 2.30 |
| Example 59 | 0.23 | 44,200 | 2.24 |
| Example 60 | 0.21 | 35,500 | 2.20 |
| Example 61 | 0.21 | 52,600 | 2.25 |
| Example 62 | 0.19 | 27,300 | 2.21 |
| Example 63 | 0.22 | 65,000 | 2.41 |
| Example 64 | 0.22 | 57,600 | 2.28 |
| Example 65 | 0.23 | 49,700 | 2.43 |
| Example 66 | 0.22 | 62,200 | 2.39 |
| Example 67 | 0.21 | 59,100 | 2.33 |
| Example 68 | 0.21 | 46,000 | 2.35 |
| Example 69 | 0.20 | 47,900 | 2.30 |
| Example 70 | 0.22 | 33,600 | 2.21 |
| Example 71 | 0.21 | 39,200 | 2.18 |
| Example 72 | 0.22 | 32,200 | 2.21 |
| Example 73 | 0.19 | 36,400 | 2.26 |
| Example 74 | 0.21 | 43,300 | 2.28 |
| Example 75 | 0.21 | 46,700 | 2.27 |
| Example 76 | 0.20 | 29,600 | 2.25 |
| Example 77 | 0.21 | 30,100 | 2.29 |
| Example 78 | 0.21 | 39,700 | 2.33 |
| Example 79 | 0.22 | 34,500 | 2.42 |
| Example 80 | 0.22 | 42,300 | 2.37 |
| Example 81 | 0.23 | 49,900 | 2.37 |
| Example 82 | 0.22 | 58,800 | 2.40 |
| Example 83 | 0.21 | 60,700 | 2.39 |
| Example 84 | 0.21 | 36,000 | 2.27 |
| Example 85 | 0.20 | 38,100 | 2.26 |
| Example 86 | 0.18 | 28,200 | 2.23 |
| Example 87 | 0.20 | 30,600 | 2.24 |
| Example 88 | 0.21 | 41,200 | 2.25 |

### Preparation of Organic EL Devices

Using spin coating at 4,000 rpm, a PEDOT:PSS layer (CH8000-LVW233, manufactured by Starck VTECH Ltd.) was applied to a glass substrate that had been subjected to patterning with a 2 mm width of ITO (indium tin oxide), and the layer was then dried by heating on a hotplate in air at 200° C. for 10 minutes. Subsequently, each of the polymer toluene solutions (1.5 wt %) obtained in the examples 5, 17 and 25, and the comparative examples 1, 2 and 3 was applied by spin coating at 3,000 rpm under a dry nitrogen atmosphere, thereby forming a polymer light-emitting layer (film thickness: 70 nm). The polymer layer was then dried by heating under a dry nitrogen atmosphere (dew point: −50° C. or lower, oxygen concentration: no higher than 10 ppm) on a hotplate at 80° C. for 5 minutes. The thus obtained glass substrate was transferred to a vacuum deposition apparatus, and an electrode was formed on the above light-emitting layer by forming sequential layers of Ba (film thickness: 5 nm) and Al (film thickness: 100 nm). Following formation of the electrode, the substrate was transferred directly to a glove box without being exposed to the external atmosphere, and under an atmosphere with a dew point of −90° C. or lower and an oxygen concentration of no higher than 1 ppm, an encapsulating glass comprising an alkali-free glass of 0.7 mm with a concave portion of 0.4 mm formed therein was bonded to the ITO substrate using a photocurable epoxy resin, thereby encapsulating the substrate. The properties of the organic EL device were measured at room temperature, by measuring the current-voltage characteristics using a picoammeter 4140B manufactured by Hewlett-Packard Company, and measuring the luminance using an SR-3 apparatus manufactured by Topcon Corporation. When a voltage was applied using the ITO as the positive electrode and the Ba/Al as the negative electrode, the results for the maximum luminance, the maximum power efficiency for a luminance within a range from 100 to 500 cd/m², and the luminance half life from 100 cd/m² (from 500 cd/m² for the example 17 and the comparative example 2) were as shown in Table 12.

TABLE 12

| | Maximum | Maximum power | Luminance |
|---|---|---|---|
| | luminance | efficiency | half life |
| | (cd/m²) | (lm/W) | (h) |
| Example 5 | 1,800 | 1.20 | 0.8 |
| Comparative example 1 | 1,300 | 0.94 | 0.6 |
| Example 17 | 5,200 | 2.16 | 373 |
| Comparative example 2 | 4,300 | 1.98 | 305 |
| Example 25 | 4,500 | 0.87 | 159 |
| Comparative example 3 | 3,500 | 0.65 | 91 |

As shown by the results above, by using the production process of the present invention, conjugated polymers with a similar molecular weight to those obtained using a typical Suzuki coupling reaction were able to be obtained with a similar yield, but with a significantly shortened reaction time. Furthermore, in the production process of the present invention, the catalysts did not undergo decomposition, and discoloration of the polymer products was also able to be prevented. Moreover, the organic EL devices prepared using the conjugated polymers obtained in the present invention exhibited superior properties of luminance, power efficiency and lifetime to organic EL devices prepared using conventional conjugated polymers.

1. A process for producing a conjugated polymer by Suzuki coupling, wherein the process uses microwave irradiation.

2. The process for producing a conjugated polymer according to claim 1, wherein the conjugated polymer is used as an organic electronics material.

3. The process for producing a conjugated polymer according to claim 1, wherein the conjugated polymer is used as an electroluminescent material.

4. An organic electronics material produced using the process for producing a conjugated polymer according to claim 1.

5. An electroluminescent material produced using the process for producing a conjugated polymer according to claim 1.

6. An electroluminescent device that uses the electroluminescent material according to claim 5.
